(19) United States
(12) Patent Application Publication
(10) Pub. No.: US 2021/0390406 A1
(43) Pub. Date: Dec. 16, 2021

(54) MACHINE LEARNING APPARATUS, MACHINE LEARNING SYSTEM, MACHINE LEARNING METHOD, AND PROGRAM

(71) Applicant: TOYOTA JIDOSHA KABUSHIKI KAISHA, Aichi-ken (JP)

(72) Inventors: Kotoru SATO, Susono-shi (JP); Daiki YOKOYAMA, Gotemba-shi (JP)

(21) Appl. No.: 17/343,736

(22) Filed: Jun. 10, 2021

(30) Foreign Application Priority Data
Jun. 11, 2020 (JP) 2020-101906

(51) Int. Cl. G06N 3/08; G06K 9/62

(52) U.S. Cl. CPC G06N 3/08; G06K 9/6228

(57) ABSTRACT

A machine learning apparatus includes an acquisition unit that acquires third data including first data and second data, the first data including at least one of parameter data collected for a plurality of collection devices and teacher data created from the parameter data, and the second data which are associated with the first data and which represent collection conditions of the parameter data; a selection unit that selects specific data from the third data; and a learning unit that performs machine learning using the specific data, and generates a trained model which is to be used for a target device. Further, the selection unit selects the specific data which are associated with the collection conditions in which a difference between usage conditions of the trained model for the target device and the collection conditions in the collection devices is equal to or less than a predetermined reference.

### CROSS-REFERENCE TO RELATED APPLICATION(S)

The present application claims priority to and incorporates by reference the entire contents of Japanese Patent Application No. 2020-101906 filed in Japan on Jun. 11, 2020.

### BACKGROUND

The present disclosure relates to a machine learning apparatus, a machine learning system, a machine learning method, and a program.

A trained model may be used at the time of predicting characteristics of a device. In the technique described in Japanese Laid-open Patent Publication No. 2019-183698, a device transmits collected data of various parameters to a server. The server performs machine learning using teacher data created from the received data, and transmits, to the device, a trained model generated by this. The device predicts the characteristics using the received trained model. A device equipped with such a trained model includes a transportation device such as a vehicle, a robot device and the like.

### SUMMARY

There is a need for providing a machine learning apparatus, a machine learning system, a machine learning method, and a program, each of which has high learning accuracy while acquiring parameter data from a plurality of devices and increasing the number of teacher data.

According to an embodiment, a machine learning apparatus includes: an acquisition unit that acquires third data including first data and second data, the first data including at least one of parameter data collected for a plurality of collection devices and teacher data created from the parameter data, and the second data which are associated with the first data and which represent collection conditions of the parameter data; a selection unit that selects specific data from the third data; and a learning unit that performs machine learning using the specific data, and generates a trained model which is to be used for a target device. Further, the selection unit selects the specific data which are associated with the collection conditions in which a difference between usage conditions of the trained model for the target device and the collection conditions in the collection devices is equal to or less than a predetermined reference.

According to an embodiment, a machine learning method includes: acquiring third data including first data and second data, the first data including at least one of parameter data collected for a plurality of collection devices and teacher data created from the parameter data, and the second data which are associated with the first data and which represent collection conditions of the parameter data; storing the third data in a storage unit; selecting specific data from the third data; and performing machine learning using the specific data read from the storage unit, and generating a trained model for use in a target device. Further, the specific data is selected, the specific data being associated with the collection conditions in which a difference between usage conditions of the trained model for the target device and the collection conditions in the collection devices is equal to or less than a predetermined reference.

According to an embodiment, provided is a non-transitory computer-readable recording medium storing a program for causing a processor having hardware to: acquire third data including first data and second data, the first data including at least one of parameter data collected for a plurality of collection devices and teacher data created from the parameter data, and the second data being associated with the first data and representing collection conditions of the parameter data; store the third data in a storage unit; select specific data from the third data; and perform machine learning using the specific data read from the storage unit, and generate a trained model for use in a target device. Further, the specific data is selected, the specific data being associated with the collection conditions in which a difference between usage conditions of the trained model for the target device and the collection conditions in the collection devices is equal to or less than a predetermined reference.

### BRIEF DESCRIPTION OF THE DRAWINGS

FIG. 1 is a schematic diagram illustrating a configuration of a machine learning system according to an embodiment;

FIG. 2 is a schematic diagram illustrating a configuration of a neural network;

FIG. 3 is a diagram illustrating an outline of inputs/outputs of nodes included in the neural network;

FIG. 4 is a sequence diagram illustrating processes executed in a collection apparatus and a server apparatus; and

FIG. 5 is a sequence diagram illustrating processes executed in a target apparatus and the server apparatus.

### DETAILED DESCRIPTION

In the related art, generally, in machine learning, the larger the number of teacher data, the higher the learning accuracy. As a method of increasing the teacher data, conceived is a method of collecting teacher data or data for creating teacher data from a plurality of devices. However, if all the data collected from various devices are used for the machine learning, the learning accuracy may inversely decrease. The decrease in the learning accuracy can be caused by the fact that non-significant variations occur in the teacher data, for example, when the devices which collect the data and devices which use the trained model are different from each other in terms of type. Moreover, even if the devices are of the same type, the learning accuracy may decrease when conditions for collecting the data and conditions for using the trained model are different from each other, and so on.

A specific description will be given below of embodiments of the present disclosure with reference to the drawings. Note that, in the drawings, the same reference numerals are appropriately assigned to the same or corresponding components, and a duplicate description will be omitted.

System Configuration

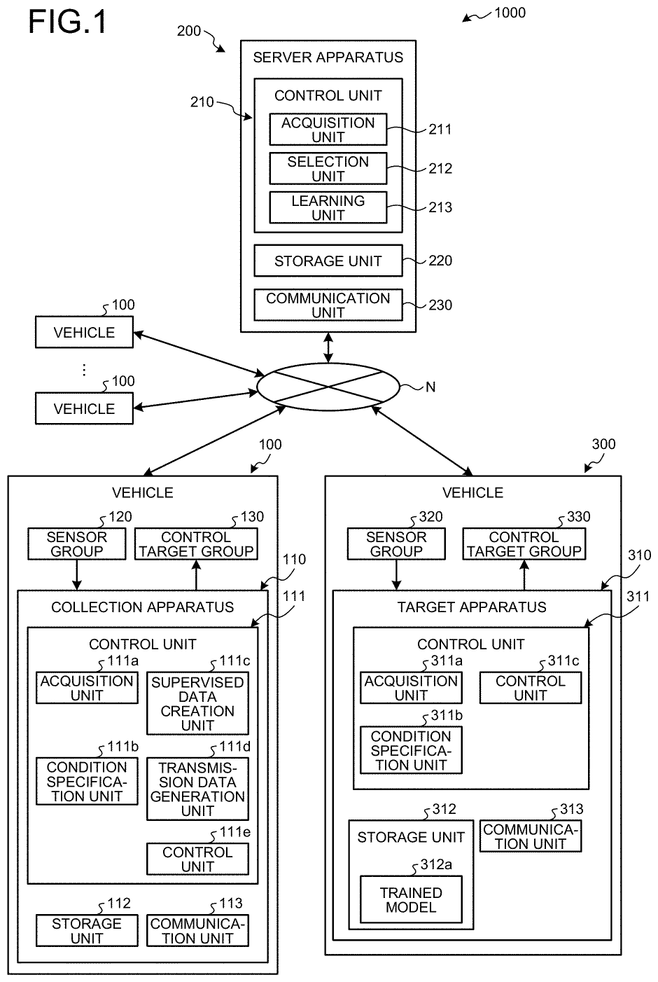

FIG. 1 is a schematic diagram illustrating a configuration of a machine learning system according to an embodiment. A machine learning system 1000 includes a plurality of collection vehicles 100, a server apparatus 200, and a target vehicle 300.

Collection Vehicle

Each of the plurality of collection vehicles 100 includes a collection apparatus 110, a sensor group 120, and a control target group 130. The collection apparatus 110, the sensor group 120, and the control target group 130 are communicably connected to one another by an in-vehicle network such as a controller area network (CAN). The collection apparatus 110 includes a control unit 111, a storage unit 112, and a communication unit 113. The collection vehicle 100 is an example of a collection device and an example of a transportation device.

For example, the control unit 111 includes a processor such as a central processing unit (CPU), a digital signal processor (DSP), and a field-programmable gate array (FPGA), and a main storage unit such as a random access memory (RAM) and a read only memory (ROM). The control unit 111 reads a program, which is stored in the storage unit 112, into a work area of the main storage unit and executes the read program, and controls each component or the like through the execution of the program by the processor, whereby hardware and software cooperate with each other to achieve function modules which meet predetermined purposes.

The control unit 111 includes, as such function modules, an acquisition unit 111a, a condition specification unit 111b, a teacher data creation unit 111c, a transmission data generation unit 111d, and a control unit 111e. The acquisition unit 111a collects, from the sensor group 120, various parameter data representing a state and characteristics of the collection vehicle 100. The condition specification unit 111b specifies collection conditions of the parameter data. For example, the condition specification unit 111b generates collection condition data representing the collection conditions of the parameter data, and thereby specifies the collection condition. The teacher data creation unit 111c creates teacher data based on the collected parameter data. The transmission data generation unit 111d generates transmission data including the teacher data and the collection condition data. The transmission data generation unit 111d associates the teacher data and the collection condition data with each other when generating the transmission data. For example, the control unit 111e determines the state and characteristics of the collection vehicle 100 based on the parameter data, and controls the control target group 130 based on a result of the determination.

The teacher data is an example of first data, the collection condition data is an example of second data, and the transmission data is an example of third data.

The storage unit 112 is composed of a storage medium such as a RAM, a hard disk drive (HDD), and a removable medium, and is also called an auxiliary storage unit. Note that the removable medium is, for example, a universal serial bus (USB) memory or a disc recording medium such as a compact disc (CD), a digital versatile disc (DVD), and a Blu-ray (registered trademark) disc (BD). Moreover, the storage unit 112 can be composed by using a computer-readable recording medium such as a memory card that can be mounted from the outside. In the storage unit 112, an operating system (OS), various programs, various tables, various databases and the like for achieving functions of the collection apparatus 110 are stored in advance, or are stored by being downloaded via a communication network.

The communication unit 113 is composed by including, for example, a data communication module (DCM), and communicates with the server apparatus 200 by wireless communication via a communication network N. The communication unit 113 transmits transmission data to the server apparatus 200. The communication network N is, for example, an Internet network that is a public communication network or the like.

The sensor group 120 is composed of a plurality of sensors which measure the state and characteristics of the collection vehicle 100. The sensor group 120 transmits measurement results as parameter data to the collection apparatus 110.

The parameter data is data representing the state and characteristics of the collection vehicle 100, and is, for example, data representing a state and characteristics, both of which are related to running of the collection vehicle 100. Examples of the parameter data include parameter data representing characteristics of the collection vehicle 100, parameter data representing usage conditions of the collection vehicle 100, and parameter data representing environmental conditions of the collection vehicle 100. The parameter data representing the characteristics of the collection vehicle 100 includes, for example, data representing a vehicle type and classification (sport utility vehicle (SUV) and the like), data representing characteristics of a drive system (electric vehicle, hybrid vehicle and the like) and a power train system, data indicating whether the vehicle is an autonomous vehicle and the like. Moreover, when the collection vehicle 100 is equipped with an internal combustion engine, then examples of the parameter data representing the characteristics of the collection vehicle 100 include an engine speed, a load factor of an engine, an air-fuel ratio of the engine, ignition timing of the engine, a concentration of hydrocarbon (HC) in exhaust gas flowing into exhaust gas purification catalyst, a concentration of carbon monoxide (CO) therein, a temperature of an exhaust gas purification catalyst and the like. The parameter data representing the usage conditions of the collection vehicle 100 includes data representing the number of passengers of the collection vehicle 100, an attribute of a driver (for example, age, gender, family composition), a driving place, a driving time zone, driving timing (season and the like) and the like. The parameter data representing the environmental conditions of the collection vehicle 100 includes data representing altitude, temperature, atmospheric pressure, weather and the like.

All of the examples of the parameter data illustrated above can be collection condition data. For example, the condition specification unit 111b selects, as the collection condition data, parameter data that affects specific parameter data, and thereby specifies a collection condition. For example, parameter data having a high degree of influence on the specific parameter data is preferentially selected as the collection condition data. Moreover, when the parameter data selected as the collection condition data has a high degree of commonality between different collection condition data sets, collection conditions expressed by those collection condition data sets can be said to be close to each other, and accordingly, the parameter data can be used to determine the closeness of the collection conditions.

The control target group 130 is controlled by the control unit 111e based on the parameter data. The control target group 130 includes various apparatuses mounted on the collection vehicle 100, and includes, for example, various apparatuses related to the running of the collection vehicle 100. When the collection vehicle 100 is equipped with an internal combustion engine, the control target group 130 includes, for example, an ignition apparatus, a fuel injection valve, a throttle valve driving actuator, an exhaust gas recirculation (EGR) control valve, a fuel pump and the like. Moreover, the control target group 130 may include a display apparatus that displays information based on the parameter data.

Server Apparatus

The server apparatus 200 is an example of a server apparatus provided with a machine learning apparatus, and includes a control unit 210, a storage unit 220, and a communication unit 230 as components of the machine learning apparatus.

Like the control unit 111 of the collection vehicle 100, the control unit 210 includes a processor and a main storage unit. The control unit 210 reads a program, which is stored in the storage unit 220, into a work area of the main storage unit and executes the read program, and controls each component or the like through the execution of the program, and thereby achieves function modules which meet predetermined purposes.

The control unit 210 includes an acquisition unit 211, a selection unit 212, and a learning unit 213 as the function modules. The acquisition unit 211 acquires transmission data transmitted from the plurality of collection vehicles 100 via the communication network N. The selection unit 212 selects specific data from the transmission data. Hereinafter, the selected data may be referred to as selection data. The learning unit 213 performs machine learning using the selection data, and generates a trained model to be used for the target vehicle 300.

The storage unit 220 is composed of a storage medium similar to the storage unit 112 of the collection vehicle 100. The storage unit 220 can store an OS, various programs, various tables, various databases and the like, which serve for achieving the functions of the server apparatus 200. Moreover, the storage unit 220 stores the trained model generated by the learning unit 213.

The communication unit 230 is composed by including, for example, a local area network (LAN) interface board and a wireless communication circuit for wireless communication, and communicates with the plurality of collection vehicles 100 and the target vehicle 300 by the wireless communication via the communication network N. For example, the communication unit 230 receives the transmission data transmitted from the plurality of collection vehicles 100.

Target Vehicle

The target vehicle 300 includes a target apparatus 310, a sensor group 320, and a control target group 330. The target apparatus 310, the sensor group 320, and the control target group 330 are communicably connected to one another by the in-vehicle network. The target apparatus 310 includes a control unit 311, a storage unit 312, and a communication unit 313. The target vehicle 300 is an example of the target device and is an example of the transportation device.

Like the control unit 111 of the collection vehicle 100, the control unit 311 includes a processor and a main storage unit. The control unit 311 reads a program, which is stored in the storage unit 312, into a work area of the main storage unit and executes the read program, and controls each component or the like through the execution of the program, and thereby achieves function modules which meet predetermined purposes. Moreover, as will be described later, the storage unit 312 stores a trained model 312a.

The control unit 311 includes an acquisition unit 311a, a condition specification unit 311b, and a control unit 311c as function modules. The acquisition unit 311a collects, from the sensor group 320, various parameter data representing a state and characteristics of the target vehicle 300. The condition specification unit 311b specifies usage conditions of a trained model 321a for the target vehicle 300, and generates usage condition data representing the usage conditions. The control unit 311c controls the control target group 330, for example, based on the characteristics predicted using the trained model 312a. The control of the control target group 330 is an example of a usage mode of the trained model 312a in the target apparatus 310.

The storage unit 312 is composed of a storage medium similar to the storage unit 112 of the collection vehicle 100. The storage unit 312 can store an OS, various programs, various tables, various databases and the like, which serve for achieving the functions of the target apparatus 310. Moreover, the storage unit 312 stores the trained model 312a. The matter that the storage unit 312 stores the trained model 312a means that the storage unit 312 stores information such as network parameters and arithmetic algorithms in the trained model 312a. Moreover, likewise hereinafter, transmission, reception, reading or the like of the trained model also means transmission, reception, reading or the like of the information such as the network parameters and the arithmetic algorithms.

The communication unit 313 is composed by including, for example, a DCM, and communicates with the server apparatus 200 by wireless communication via the communication network N. The communication unit 313 transmits, for example, usage condition data to the server apparatus 200.

The sensor group 320 is composed of a plurality of sensors which measure a state and characteristics of the target vehicle 300. The sensor group 320 transmits measurement results as parameter data to the target apparatus 310.

The parameter data is data representing the state and characteristics of the target vehicle 300, and is, for example, data representing a state and characteristics, both of which are related to running of the target vehicle 300. The parameter data includes those illustrated above as the parameter data of the collection vehicle 100. That is, examples of the parameter data include parameter data representing the characteristics of the target vehicle 300 or parameter data representing environmental conditions of the target vehicle 300. Moreover, all of the illustrated parameter data can be the usage condition data. For example, the condition specification unit 311b selects, as the usage condition data, parameter data that affects specific parameter data, and thereby specifies usage conditions. For example, parameter data having a high degree of influence on the specific parameter data is preferentially selected as the usage condition data.

The control target group 330 is controlled by the control unit 311c based on the parameter data. The control target group 330 includes various apparatuses mounted on the target vehicle 300, and includes, for example, various apparatuses related to the running of the target vehicle 300. Moreover, the control target group 330 may include a display apparatus that displays information based on predictions by the parameter data and the trained model 312a.

Example of Machine Learning

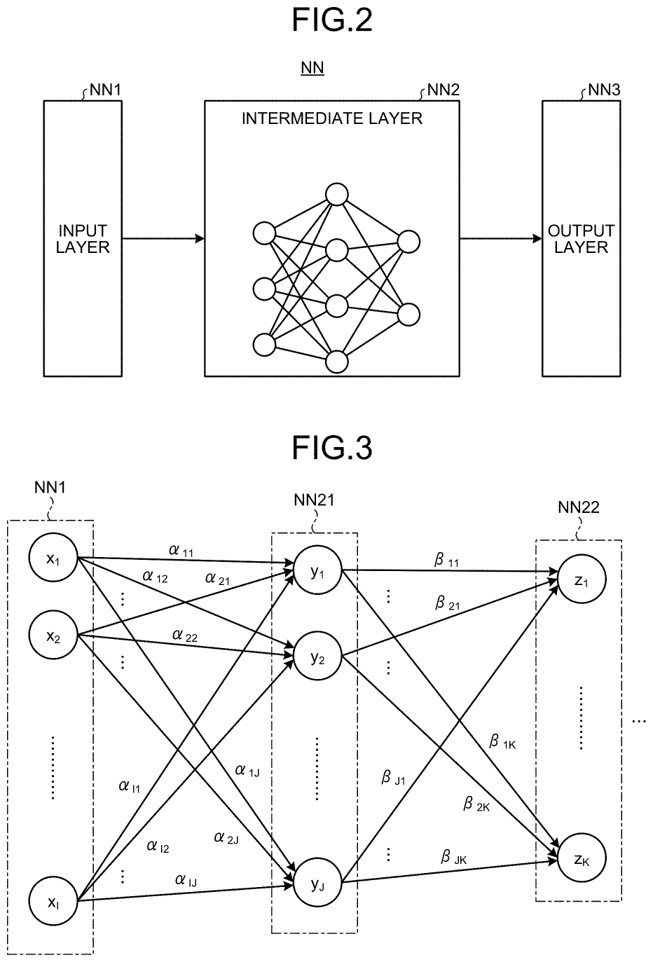

Next, deep learning using a neural network will be described as an example of a method of the machine learning executed by the learning unit 213 of the server apparatus 200. FIG. 2 is a schematic diagram illustrating a configuration of the neural network learned by the learning unit 213. A neural network NN is a feedforward neural network, and has an input layer NN1, an intermediate layer NN2, and an output layer NN3. The input layer NN1 is composed of a plurality of nodes, and input parameters different from one another are input to the respective nodes. Outputs from the input layer NN1 are input to the intermediate layer NN2. The intermediate layer NN2 has a multi-layered structure including a layer composed of a plurality of nodes which receive such inputs from the input layer NN1. The output layer NN3 receives output from the intermediate layer NN2, and outputs an output parameter. Machine learning using a neural network in which the intermediate layer NN2 has a multi-layered structure is called deep learning.

FIG. 3 is a diagram illustrating an outline of inputs/outputs at the nodes provided in the neural network NN. In FIG. 3, a part of inputs/outputs of data in an input layer NN1 having I nodes in the neural network NN, a first intermediate layer NN21 having J nodes therein, and a second intermediate layer NN22 having K nodes therein is schematically illustrated (I, J, K are positive integers). An input parameter xᵢ (i=1, 2, . . . , I) is input to an i-th node from the top of the input layer NN1. Hereinafter, a set of all input parameters will be described as “input parameter {xᵢ}”.

Each node of the input layer NN1 outputs a signal, which has a value obtained by multiplying the input parameter by a predetermined weight, to each node of the first intermediate layer NN21 adjacent thereto. For example, the i-th node from the top of the input layer NN1 outputs a signal, which has a value αᵢⱼxᵢ obtained by multiplying the input parameter xᵢ by a weight αᵢⱼ, to a j-th (j=1, 2, . . . , J) node from the top of the first intermediate layer NN21. To the j-th node from the top of the first intermediate layer NN21, there is input a value Σ_{i=1˜I}αᵢⱼxᵢ+b⁽¹⁾ⱼ obtained by adding a predetermined bias b⁽¹⁾ⱼ totally to the outputs from the respective nodes of the input layer NN1. Here, Σ_{i=1˜I} in a first item means to take the sum of i=1, 2, . . . , I.

An output value yⱼ of the j-th node from the top of the first intermediate layer NN21 is expressed as yⱼ=S(Σ_{i=1˜I}αᵢⱼxᵢ+b⁽¹⁾ⱼ) as a function of an input value Σ_{i=1˜I}αᵢⱼxᵢ+b⁽¹⁾ⱼ from the input layer NN1 to that node. This function S is called an activation function. Examples of a specific activation function can include the sigmoid function S(u)=1/{1+exp (−u)}, the rectified linear function (ReLU)S(u)=max(0, u) and the like. A non-linear function is often used as the activation function.

Each node of the first intermediate layer NN21 outputs a signal, which has a value obtained by multiplying the input parameter by a predetermined weight, to each node of the second intermediate layer NN22 adjacent thereto. For example, the j-th node from the top of the first intermediate layer NN21 outputs a signal, which has a value βⱼₖyⱼ obtained by multiplying the input value yⱼ by a weight βⱼₖ, to a k-th (k=1, 2, . . . , K) node from the top of the second intermediate layer NN22. To the k-th node from the top of the second intermediate layer NN22, there is input a value Σ_{j=1˜J}βⱼₖyⱼ+b⁽²⁾ₖ obtained by adding a predetermined bias b⁽²⁾ₖ totally to the outputs from the respective nodes of the first intermediate layer NN21. Here, Σ_{j=1˜J} in a first item means to take the sum of j=1, 2, . . . , J.

An output value zₖ of the k-th node from the top of the second intermediate layer NN22 is expressed as zₖ=S(Σ_{j=1˜J}βⱼₖyⱼ+b⁽²⁾ₖ) using an activation function that takes, as a variable, the input value Σ_{j=1˜J}βⱼₖyⱼ+b⁽²⁾ₖ from the first intermediate layer NN21 to that node.

As mentioned above, the inputs of the signals are sequentially repeated in a forward direction from the input layer NN1 toward the output layer NN3, whereby one output parameter Y is finally output from the output layer NN3. The weights and the biases, which are contained in the neural network NN, are also collectively called a network parameter w. This network parameter w is a vector of which components are all the weights and biases of the neural network NN.

The learning unit 213 performs an arithmetic operation for updating the network parameter based on the output parameter Y calculated by inputting the input parameter {xᵢ} to the neural network NN and on an output parameter (target output) Y₀ that constitutes an input/output data set together with the input parameter {xᵢ}. Specifically, an arithmetic operation for minimizing an error between the two output parameters Y and Y₀ is performed, whereby the network parameter w is updated. In this case, the stochastic gradient descent is often used. Hereinafter, a set ({xᵢ}, Y) of the input parameter {xᵢ} and the output parameter Y is collectively referred to as “teacher data”.

In the stochastic gradient descent, the network parameter w is sequentially updated like w′=w−η∇_{w}E(w), w″=w′−η∇_{w′}E(w′), . . . , using a predetermined learning rate η determined automatically or manually. Note that the learning rate η may be changed during learning. The learning unit 213 repeats the above-mentioned update process. Thus, the error function E (w) gradually approaches a minimum point. Note that, in the case of more general stochastic gradient descent, the error function E(w) is defined at each update process by being randomly extracted from samples including all the teacher data, and is also applicable in the present embodiment.

Process Sequence in Collection Apparatus and Server Apparatus

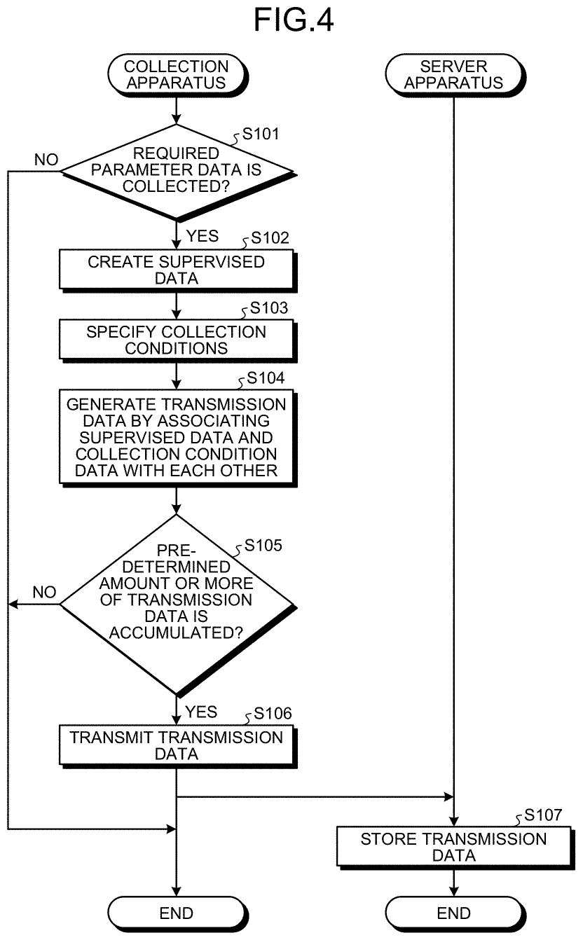

FIG. 4 is a sequence diagram illustrating processes executed in the collection apparatus 110 and the server apparatus 200. The sequence is repeatedly executed, for example, in a predetermined cycle. Note that, though the process of one collection apparatus 110 is described in FIG. 4, the process is similarly executed in the collection apparatus 110 of each collection vehicle 100.

First, in Step S101, the control unit 111 of the collection apparatus 110 determines whether the acquisition unit 111a has collected the parameter data necessary to create the teacher data. In the case of determining that the acquisition unit 111a has not collected the parameter data (Step S101: No), the control unit 111 ends the process. When the control unit 111 determines that the acquisition unit 111a has collected the parameter data (Step S101: Yes), the sequence proceeds to Step S102.

In Step S102, the teacher data creation unit 111c creates teacher data based on the collected parameter data. For example, when predicting a temperature of an exhaust gas purification catalyst by machine learning, a set of the parameter data can be the teacher data. The parameter data include an engine speed, a load factor of an engine, an air-fuel ratio of the engine, ignition timing of the engine, a concentration of HC in exhaust gas flowing into exhaust gas purification, a concentration of CO therein, and a temperature of the exhaust gas purification catalyst. When creating the teacher data, the teacher data creation unit 111c appropriately performs preprocesses such as deletion and complementation of missing data, and normalization and standardization of data.

Subsequently, in Step S103, the condition specification unit 111b generates collection condition data representing the collection conditions of the parameter data, and thereby specifies the collection conditions. For example, the condition specification unit 111b selects, as the collection condition data, parameter data that affects parameter data (input parameter or output parameter) constituting the teacher data created by the teacher data creation unit 111c, and thereby specifies the collection condition. For example, parameter data having a high degree of influence on the parameter data constituting the teacher data is preferentially selected as the collection condition data.

Subsequently, in Step S104, the transmission data generation unit 111d associates the teacher data and the collection condition data with each other, and generates transmission data including the teacher data and the collection condition data. The transmission data generation unit 111d stores the generated transmission data in the storage unit 112.

Subsequently, in Step S105, the control unit 111 determines whether a predetermined amount or more of the transmission data is accumulated in the storage unit 112. Data representing a predetermined amount is stored in the storage unit 112. In the case of determining that a predetermined amount or more of the data is not accumulated in the storage unit 112 (Step S105: No), the control unit 111 ends the process. When the control unit 111 determines that a predetermined amount or more of the data is accumulated in the storage unit 112 (Step S105: Yes), the sequence proceeds to Step S106.

In Step S106, the control unit 111 reads the transmission data from the storage unit 112, and causes the communication unit 113 to transmit the transmission data. Hence, the predetermined amount in Step S105 is an amount for setting transmission timing of the transmission data. Thereafter, the sequence of the collection apparatus 110 ends.

In the server apparatus 200, when the communication unit 230 receives the transmission data transmitted from the communication unit 113, the control unit 210 stores the transmission data in the storage unit 220 in Step S107. The storage unit 220 stores a plurality of the transmission data transmitted from the plurality of collection apparatuses 110. That is, the storage unit 220 stores a plurality of the teacher data created from the parameter data collected by the plurality of collection apparatuses 110, and collection condition data associated with the respective teacher data.

Process Sequence in Target Apparatus and Server Apparatus

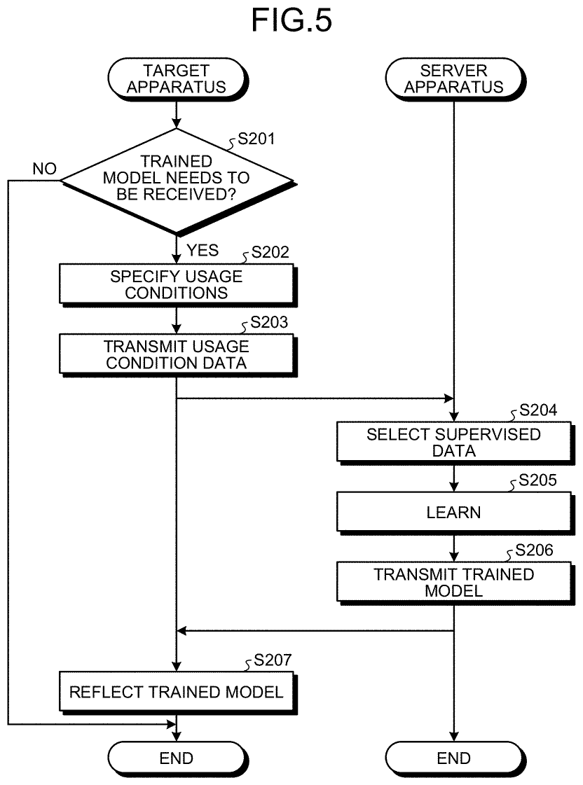

FIG. 5 is a sequence diagram illustrating processes executed in the target apparatus 310 and the server apparatus 200. The sequence is repeatedly executed, for example, in a predetermined cycle.

First, in Step S201, the control unit 311 of the target apparatus 310 determines whether the target apparatus 310 needs to receive the trained model. For example, in the case of determining that a predetermined period has passed from a creation date and time of the trained model 312a actually stored in the storage unit 312 or the previous update date and time, or in the case of determining that a trained model different from the trained model 312a actually stored in the storage unit 312 is required, the control unit 311 determines that the trained model needs to be received. In the case of determining that the trained model does not need to be received (Step S201: No), the control unit 311 ends the process. When the control unit 311 determines that the trained model needs to be received (Step S201: Yes), the sequence proceeds to Step S202.

In Step S202, the condition specification unit 311b generates usage condition data representing the usage conditions of the trained model 321a for the target vehicle 300, and thereby specifies the usage conditions. For example, the condition specification unit 311b selects parameter data that affects the input parameter or output parameter of the trained model 312a to generate the usage condition data, and thereby specifies the usage conditions. For example, parameter data having a high degree of influence on the input parameter or output parameter of the trained model 312a is preferentially selected as the usage condition data. The condition specification unit 311b stores the generated usage condition data in the storage unit 312.

Subsequently, in Step S203, the control unit 311 reads the usage condition data from the storage unit 312, and causes the communication unit 313 to transmit the usage condition data.

In the server apparatus 200, when the communication unit 230 receives the usage condition data transmitted from the communication unit 313, the control unit 210 stores the usage condition data in the storage unit 220.

Subsequently, in Step S204, the selection unit 212 of the control unit 210 selects collection condition data close to the usage condition data among the collection condition data included in the plurality of transmission data stored in the storage unit 220, and further selects teacher data associated with the selected collection condition data. The selected teacher data is an example of specific data selected from the transmission data by the selection unit 212.

The collection condition data to be selected is collection condition data that is close to the usage condition data by more than a predetermined reference. The closeness between the usage condition data and the collection condition data is determined using various indices, for example, such as a distance between the data, a degree of similarity, and a correlation coefficient. Moreover, the predetermined reference is set according to, for example, required learning accuracy, and is stored in the storage unit 220 in advance, for example.

Subsequently, in Step S205, the learning unit 213 of the control unit 210 performs machine learning by the above-mentioned method or the like using the selected teacher data, and generates a trained model. The control unit 210 stores the generated trained model in the storage unit 220.

Subsequently, in Step S206, the control unit 210 reads the trained model from the storage unit 220, and causes the communication unit 230 to transmit the trained model. Thereafter, the server apparatus 200 ends the process.

Subsequently, in Step S207, the communication unit 313 of the target apparatus 310 receives the trained model from the server apparatus 200, and the control unit 311 stores the trained model in the storage unit 312, and reflects the trained model to the target apparatus 310. Note that, in the present embodiment, the trained model 312a is stored in the storage unit 312 in advance. In this case, the trained model is reflected to the target apparatus 310, for example, as follows. That is, for example, the control unit 311 may perform an update process of deleting such a previous trained model and replacing the deleted trained model with a latest trained model received from the server apparatus 200, the latest trained model serving as the trained model 312a. Moreover, the control unit 311 may construct a new trained model 312a by performing an accumulation process of writing a latest trained model while leaving a part or all of the previous trained model. Thereafter, the target apparatus 310 ends the process.

The target apparatus 310 can, for example, perform more appropriate control of the control target group 330 using the trained model generated by the server apparatus 200.

In the above-described machine learning system 1000 having the machine learning apparatus, when the trained model for use in the target vehicle 300 is generated, the teacher data associated with the collection conditions close to the usage conditions of the trained model is selected from the teacher data created from the parameter data collected in the collection apparatus 110 for the plurality of collection vehicles 100, and the machine learning is performed using the selected data. As a result, there can be achieved the machine learning apparatus that has high learning accuracy while acquiring the parameter data from the plurality of collection vehicles 100 and increasing the number of teacher data.

Moreover, the collection conditions include at least one of conditions representing the characteristics of the collection vehicle 100, the usage conditions of the collection vehicle 100, and the environmental conditions of the collection vehicle 100, and the usage conditions include at least one of the conditions representing the characteristics of the target vehicle 300, and the environmental conditions of the target vehicle 300, and accordingly, the teacher data can be selected based on various collection conditions or usage conditions.

Moreover, since the machine learning apparatus includes the communication unit 230 that transmits the trained model to the target vehicle 300, the target vehicle 300 can use, in the target vehicle 300 itself, the trained model transmitted from the machine learning apparatus.

Further, in the machine learning system 1000, the server apparatus 200 can centrally acquire the data for the machine learning and create the trained model.

Moreover, since the collection apparatus 110 includes the teacher data creation unit 111c, the collection apparatus 110 can take on the function to create the teacher data as well as the function to collect the parameter data.

Note that, in the above embodiment, the collection apparatus 110 includes the teacher data creation unit 111c; however, the machine learning apparatus may include the teacher data creation unit. In this case, the collection apparatus transmits, as transmission data, third data including the first data that is the collected parameter data and the second data that is the collection condition data of the parameter data and is associated with the first data to the machine learning apparatus. In the machine learning apparatus, the selection unit selects specific data from the third data, and the teacher data creation unit creates teacher data based on the specific data. Moreover, the collection apparatus and the machine learning apparatus may have the teacher data creation function in a distributed manner. In this case, the first data can include both the parameter data and the teacher data.

Moreover, the machine learning apparatus may be provided in one of apparatuses other than the server apparatus connected to the communication network N, and the components of the machine learning apparatus may be provided in a plurality of other apparatuses connected to the communication network N in a distributed manner. The other apparatuses are, for example, collection apparatuses, target apparatuses, other computer apparatuses, or the like.

Moreover, without being mounted on the collection vehicle, the collection apparatus may collect the parameter data from the collection vehicles via the communication network.

Further, in the above embodiment, the collection vehicles and the target vehicle can be replaced with other transportation devices and robot devices.

It is noted that the present disclosure is not limited to the above embodiments. The present disclosure includes modifications formed by preferably combining the above elements described above. Further, further effects and modified examples can be easily derived by a person skilled in the art. Therefore, wider embodiments of the present disclosure are not limited to the embodiments described above, and various modifications can be made.

According to the present disclosure, the learning accuracy can be enhanced while increasing the number of supervised data.

According to an embodiment, at the time of generating a trained model for use in a target device, the machine learning apparatus selects data, which is associated with collection conditions close to usage conditions of the trained model, from at least one of parameter data collected for a plurality of collection devices and teacher data created from the parameter data, and then performs machine learning using the selected data. Accordingly, there can be achieved the machine learning apparatus that has high learning accuracy while acquiring parameter data from a plurality of devices and increasing the number of teacher data.

According to an embodiment, the machine learning apparatus can select data based on various collection conditions or usage conditions.

According to an embodiment, in a subject vehicle, the target device can use a trained model transmitted from the machine learning apparatus.

According to an embodiment, there can be achieved the machine learning system that has high learning accuracy while acquiring parameter data from a plurality of devices and increasing the number of teacher data.

According to an embodiment, a machine learning system including a transportation device such as vehicles can be achieved.

According to an embodiment, a server apparatus can centrally acquire data for machine learning and create a trained model.

According to an embodiment, a collection apparatus can take on a function to create the teacher data as well as a function to collect the parameter data.

According to an embodiment, there can be achieved the machine learning method that has high learning accuracy while acquiring parameter data from a plurality of devices and increasing the number of teacher data.

According to an embodiment, a processor can be caused to execute the machine learning method that has high learning accuracy while acquiring parameter data from a plurality of devices and increasing the number of teacher data.

Although the disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A machine learning apparatus comprising:
an acquisition unit that acquires third data including first data and second data, the first data including at least one of parameter data collected for a plurality of collection devices and teacher data created from the parameter data, and the second data which are associated with the first data and which represent collection conditions of the parameter data;
a selection unit that selects specific data from the third data; and
a learning unit that performs machine learning using the specific data, and generates a trained model which is to be used for a target device, wherein
the selection unit selects the specific data which are associated with the collection conditions in which a difference between usage conditions of the trained model for the target device and the collection conditions in the collection devices is equal to or less than a predetermined reference.

2. The machine learning apparatus according to claim 1, wherein
the collection conditions include at least one of a condition representing characteristics of the collection devices, a usage condition of the collection devices, and an environmental condition of the collection devices, and
the usage conditions include at least one of a condition representing characteristics of the target device and an environmental condition of the target device.

3. The machine learning apparatus according to claim 1, further comprising
a communication unit that transmits the trained model to the target device.

4. A machine learning system comprising:
a collection apparatus that collects the parameter data of the collection devices;
a target apparatus that uses the trained model in the target device; and
the machine learning apparatus according to claim 1.

5. The machine learning system according to claim 4, wherein
the collection devices or the target device is a transportation device.

6. The machine learning system according to claim 4, wherein
the machine learning apparatus is provided in a server apparatus.

7. The machine learning system according to claim 4, wherein
the collection apparatus includes a teacher data creation unit that creates the teacher data from the parameter data.

8. A machine learning method comprising:
acquiring third data including first data and second data, the first data including at least one of parameter data collected for a plurality of collection devices and teacher data created from the parameter data, and the second data which are associated with the first data and which represent collection conditions of the parameter data;
storing the third data in a storage unit;
selecting specific data from the third data; and
performing machine learning using the specific data read from the storage unit, and generating a trained model for use in a target device, wherein
the specific data is selected, the specific data being associated with the collection conditions in which a difference between usage conditions of the trained model for the target device and the collection conditions in the collection devices is equal to or less than a predetermined reference.

9. A non-transitory computer-readable recording medium storing a program for causing a processor having hardware to:
acquire third data including first data and second data, the first data including at least one of parameter data collected for a plurality of collection devices and teacher data created from the parameter data, and the second data being associated with the first data and representing collection conditions of the parameter data;
store the third data in a storage unit;
select specific data from the third data; and
perform machine learning using the specific data read from the storage unit, and generate a trained model for use in a target device, wherein
the specific data is selected, the specific data being associated with the collection conditions in which a difference between usage conditions of the trained model for the target device and the collection conditions in the collection devices is equal to or less than a predetermined reference.
